(19) United States
(12) Patent Application Publication
(10) Pub. No.: US 2011/0225414 A1
(43) Pub. Date: Sep. 15, 2011

(54) MONITOR WITH CIRCUIT FOR CLEARING CMOS DATA AND COMPUTER MOTHERBOARD

(75) Inventor: HAI-QING ZHOU, Shenzhen City (CN)

(73) Assignees: HONG FU JIN PRECISION INDUSTRY (ShenZhen ) CO., LTD., Shenzhen City (CN); HON HAI PRECISION INDUSTRY CO., LTD., Tu-Cheng (TW)

(21) Appl. No.: 12/752,165

(22) Filed: Apr. 1, 2010

(30) Foreign Application Priority Data
Mar. 10, 2010 (CN) 201010120619.8

(51) Int. Cl. G06F 9/22

(52) U.S. Cl. 713/100

(57) ABSTRACT

A monitor for clearing CMOS data of a motherboard includes a jumper block including a first pin and a second pin. A power circuit connects to a display circuit to provide power to the display circuit. The power circuit is connected to ground via a resistor and a capacitor connected in series. An idle pin of the monitor video interface jumper block to a node between the first resistor and the first capacitor, and connects to the second pin of the jumper block. The first pin of the jumper block goes to ground. A positive terminal of a battery connects to the power circuit, and a negative terminal of the battery connects to ground.

### BACKGROUND

1. Field of the Invention

The present disclosure relates to a monitor with a circuit for clearing complementary metal oxide semiconductor (CMOS) data and a computer motherboard.

2. Description of Related Art

With regard to electronic computers, jumpers are generally used to adjust connections of electrical components on printed circuit boards, such as motherboards of computers. In general, each contact point in a jumper block terminates by a small metal pin.

When an error in the Basic Input/Output System (BIOS) occurs or the CMOS password is forgotten, the jumpers may be set to clear the CMOS information in the south bridge chip, and reset the BIOS configuration settings. However, using the jumper to clear the CMOS information is time-consuming and inefficient because the computer enclosure must be taken apart before clearing the CMOS information in the south bridge chip.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a monitor in accordance with an exemplary embodiment of the present disclosure, the monitor including a jumper block.

FIG. 2 is similar to FIG. 1, but showing the jumper block connecting with a jumper.

FIG. 3 is a circuit schematic diagram of the monitor in accordance with an exemplary embodiment of the present disclosure.

### DETAILED DESCRIPTION

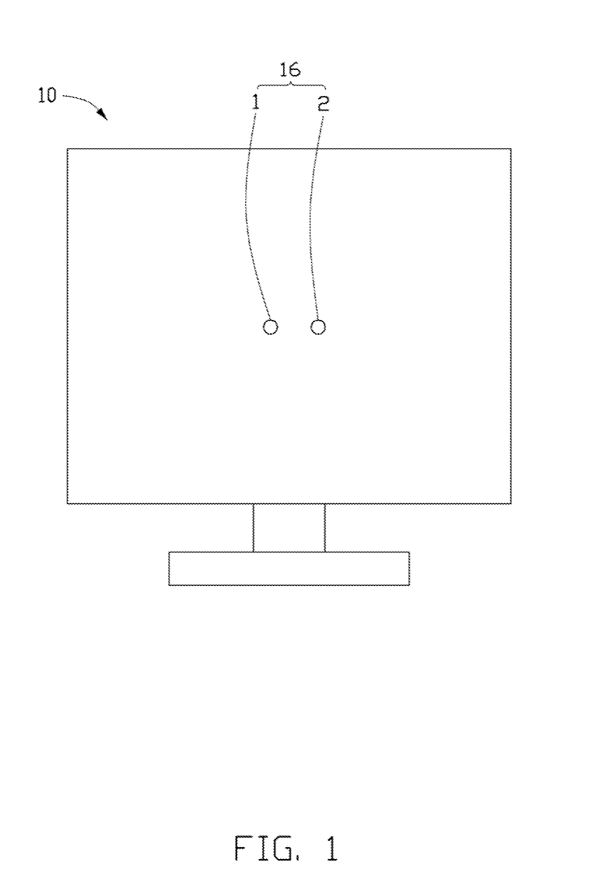

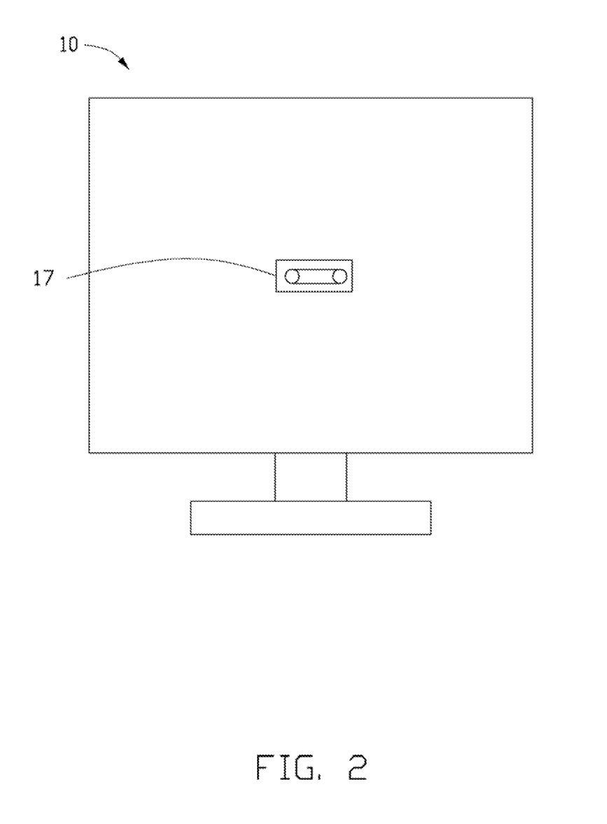

Referring to FIGS. 1 and 2, a monitor 10 with a circuit for clearing complementary metal oxide semiconductor (CMOS) data of a computer (not shown) in accordance with an exemplary embodiment includes a jumper block 16, which is set on a rear of the monitor 10, to clear the CMOS data of the computer. The jumper block 16 includes two pins 1 and 2, the pins 1 and 2 are not connected to each other directly. The pins 1 and 2 of the jumper block 16 may be set anywhere on the rear of the monitor 10. The pins 1 and 2 of the jumper block 16 can be electrically connected together via a jumper 17.

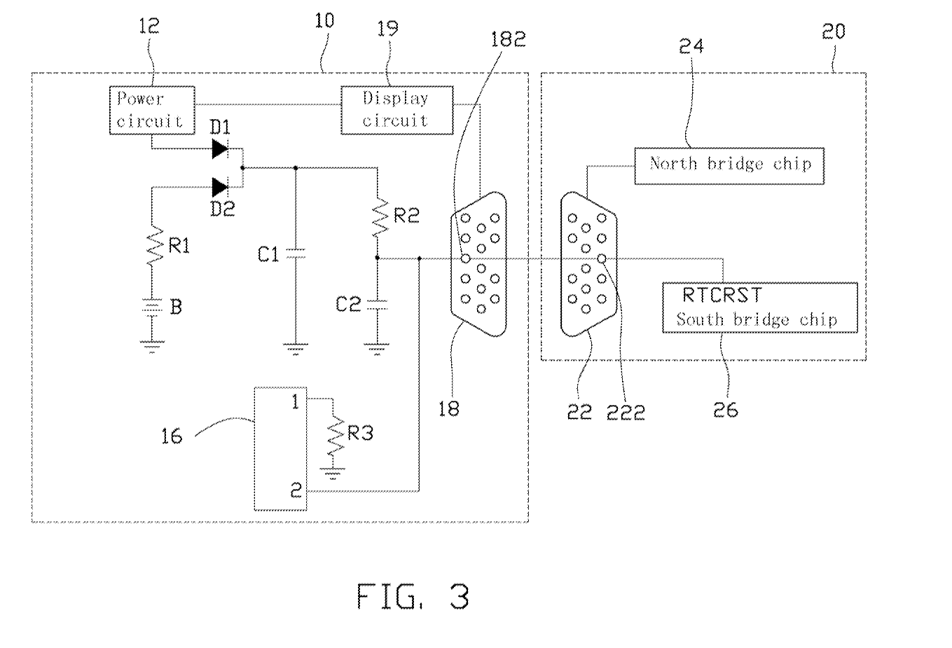

Referring to FIG. 3, the monitor 10 further includes a power circuit 12, a monitor video interface 18, such as a video graphics array (VGA) interface, a display circuit 19, a battery B, diodes D1 and D2, resistors R1-R3, and capacitors C1 and C2. The monitor video interface 18 includes a plurality of video pins and a plurality of idle pins. The power circuit 12, the display circuit 19, the battery B, the diodes D1 and D2, resistors R1-R3, and capacitors C1 and C2 are set on a printed circuit board (not shown) of the monitor 10. The power circuit 12 connects to the display circuit 19, to provide voltages to the display circuit 19. The power circuit 12 and the display circuit 19 are known circuits of a common computer monitor.

The power circuit 12 also connects to an anode of the diode D1. A cathode of the diode D1 connects to a cathode of the diode D2. An anode of the diode D2 connects to a positive terminal of the battery B via the resistor R1. A negative terminal of the battery B goes to ground. The cathode of diode D1 is connected to one terminal of the capacitor C1, the other terminal of the capacitor C1 is grounded. The cathode of diode D1 is connected to one terminal of R2. The other terminal of R2 is connected to one terminal of C2. The other terminal of C2 is grounded. An idle pin 182 of the plurality of idle pins of the monitor video interface 18 connects to a node between the resistor R2 and the capacitor C2, and connects to the pin 2 of the jumper block 16. The pin 1 of the jumper block 16 goes to ground via the resistor R3. The plurality of video pins of the monitor video interface 18 connects to the display circuit 19.

A motherboard 20 of the computer connects to the monitor 10, and includes a motherboard video interface 22 (such as a VGA interface), a north bridge chip 24, and a south bridge chip 26. The south bridge chip 26 includes a reset signal pin RTCRST to output reset signals to clear the CMOS data of the computer. The motherboard video interface 22 includes a plurality of video pins and a plurality of idle pins. An idle pin 222 of the plurality of idle pins of the motherboard video interface 22 corresponding to the idle pin 182 of the monitor video interface 18 connects to the reset signal pin RTCRST of the south bridge chip 26. The video pins of the monitor video interface 22 connect to the north bridge chip 24.

In use, the monitor video interface 18 plugs into the motherboard video interface 22, with the idle pin 182 connecting to the idle pin 222 and the plurality of video pins of the monitor video interface 18 connecting to the plurality of video pins of the motherboard video interface 22. The monitor 10 turns on. The power circuit 12 converts alternating current (AC) power into 3.3 volt (V) direct current (DC) power and provides the 3.3V DC power to the diode D1, to turn on the diode D1. The power circuit 12 outputs a high level signal to the reset signal pin RTCRST of the south bridge chip 26 via the resistor R2 and the idle pins 182 and 222. When the reset pin RTCRST of the south bridge chip 26 receives the high level signal, the south bridge chip 26 does not clear CMOS data. If the motherboard 20 powers on, the motherboard 20 will execute an operation system of the computer according to CMOS data stored in the south bridge chip 26. When the monitor 10 does not turn on, the battery B provides voltage to the diode D2 via the resistor R1, to turn on the diode D2. The battery B outputs a high level signal to the reset signal pin RTCRST of the south bridge chip 26 via the idle pins 182 and 222. When the reset signal pin RTCRST of the south bridge chip 26 receive the high level signal, the south bridge chip 26 does not clear CMOS data. If the motherboard 20 powers on, the motherboard 20 will execute the operation system according to CMOS data stored in the south bridge chip 26.

If the south bridge chip 26 needs to clear CMOS data, the jumper 17 can plug into the pins 1 and 2 of the jumper block 16. Due to the fact that pin 1 of the jumper block 16 goes to ground via the resistor R3, the pin 2 of the jumper block 16 outputs a low level signal to the reset signal pin RTCRST of the south bridge chip 26 via the idle pins 182 and 222. When the reset signal pin RTCRST of the south bridge chip 26 receives the low level signal, the south bridge chip 26 clears the CMOS data. If the jumper 17 is removed from the pins 1 and 2 of the jumper block 16, the reset signal pin RTCRST of the south bridge chip 26 is reset at a high level signal, and the south bridge chip 26 reset the CMOS data.

In one embodiment, the diodes D1 and D2 can prevent reverse current, the diodes D1 and D2 can be deleted according to need.

The monitor 10 can trigger the reset signal pin RTCRST of the south bridge chip 26 through connecting the jumper 17 to the pins 1 and 2 of the jumper block 16, to clear COMS data.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A monitor for clearing CMOS data of a motherboard connected to the monitor, the monitor comprising:
a first resistor;
a first capacitor;
a jumper block comprising a first pin and a second pin, the first pin of the jumper block connected to ground;
a display circuit;
a power circuit to output a high level signal when the monitor being turned on, the power circuit connected to the display circuit, to provide power to the display circuit, the power circuit connected to one terminal of the first resistor, the other terminal of the first resistor connected to one terminal of the first capacitor, the other terminal of the first capacitor being grounded;
a monitor video interface comprising a plurality of video pins and a plurality of idle pins, the plurality of video pins connected to the display circuit, one of the plurality of idle pins connected to a node between the first resistor and the first capacitor, and connected to the second pin of the jumper block; and
a battery to output a high level signal when the monitor not being turned on, the battery comprising a positive terminal connected to the power circuit, and a negative terminal connected to ground.

2. The monitor as claimed in claim 1, wherein the first and second pins of the jumper block are set in the rear of the monitor.

3. The monitor as claimed in claim 1, wherein the monitor video interface is a monitor video graphics array (VGA) interface.

4. The monitor as claimed in claim 1, further comprising a first diode and a second diode, wherein an anode of the first diode connects to the power circuit, a cathode of the first diode connects to the first resistor, an anode of the second diode connects to the positive terminal of the battery, a cathode of the second diode connects to the cathode of the first diode.

5. The monitor as claimed in claim 4, further comprising a second resistor, a second capacitor, and a third resistor, wherein the second resistor connects between the positive terminal of the battery and the anode of the second diode, the second capacitor connects between the cathode of the second diode and ground, the third resistor connects between the first pin of the jumper block and ground.

6. A monitor system comprising:
a monitor comprising:
a first resistor;
a first capacitor;
a jumper block comprising a first pin and a second pin, the first pin connected to ground;
a display circuit;
a power circuit to output a high level signal when the monitor being turned on, the power circuit connected to the display circuit, to provide power to the display circuit, the power circuit connected to one terminal of the first resistor, the other terminal of the first resistor connected to one terminal of the first capacitor, the other terminal of the first capacitor being grounded;
a monitor video interface comprising a plurality of video pins and a plurality of idle pins, the plurality of video pins connected to the display circuit, one of the plurality of idle pins of the monitor video interface connected to a node between the first resistor and the first capacitor, and connected to the second pin of the jumper block; and
a battery to output a high level signal when the monitor not being turned on, the battery comprising a positive terminal connected to the power circuit, and a negative terminal connected to ground; and
a computer motherboard comprising:
a south bridge chip comprising a reset signal pin, to clear complementary metal oxide semiconductor (CMOS) data;
a north bridge chip; and
a motherboard video interface mating with the monitor video interface, the motherboard video interface comprising a plurality of video pins connected to the north bridge chip and the plurality of video pins of the monitor video interface, and a plurality of idle pins connected to the plurality of idle pins of the monitor video interface, one of the plurality of idle pins of the motherboard video interface connected to the reset signal pin of the south bridge chip.

7. The monitor system as claimed in claim 6, wherein the monitor video interface is a video graphics array (VGA) interface, and the motherboard video interface is a motherboard VGA interface.
